(19) United States
(12) Patent Application Publication
(10) Pub. No.: US 2019/0122279 A1
(43) Pub. Date: Apr. 25, 2019

(54) JEWELRY CUSTOMIZATION SYSTEM

(71) Applicant: A&I INC., Van Nuys, CA (US)

(72) Inventors: Yuri Mordovskoi, Pacific Palisades, CA (US); Armen Nalbandian, Pacific Palisades, CA (US)

(21) Appl. No.: 15/565,888

(22) PCT Filed: May 1, 2015
(86) PCT No.: PCT/US15/28740

§ 371 Date: Oct. 11, 2017

(51) Int. Cl. G06Q 30/06; G06F 16/955

(52) U.S. Cl. CPC G06Q 30/0621; G06Q 30/0641; G06F 16/955

(57) ABSTRACT

A personalized jewelry customization system that displays ready-made smart jewelry element models, from a library, to a customer to construct a final jewelry model that is easy to use. The system has one or more than one processor, a storage for storing executable instructions. The instructions provide a user interface displayable on a computing device, a library of smart jewelry element models, a database for storing customer and selection information, and for automatically generated manufacturing instructions for the personalized jewelry and complementary jewelry based on the stored customer information and selection information. The user interface, displayed on a computing device, accepts jewelry customization instructions from the customer to combine smart jewelry element models together to create the final jewelry model that is stored in the database.

### FIELD OF THE INVENTION

The present invention relates to personalized jewelry customization and more specifically to a personalized jewelry customization system that displays ready-made smart jewelry element models, from a library, to a customer to construct a final jewelry model that is easy to use.

### BACKGROUND

Efforts have been made to customize jewelry in various forms. For example, United States Patent Application No. 2012/0304129 A1 describes an online system to configure jewelry. Unfortunately, the only customizations available are for standard rings from a catalog. The customer starts making selections provided by the catalog, such as, for example, the mounting, setting, diamond, etc., but these selections simply limit the catalog to the available items that match what is already available. Real customization is not possible. Additionally, the described system only allows for layers of changes to be applied to a static catalog image. This type of color ‘customization’ has been used by clothing and automobile manufacturers for years. With a limited inventory, the only real customizations available are color, metal type, metal quality, metal color, gemstone's type and a few other options that can easily be overlaid using layers on a standard template. This does not solve the problem of allowing a customer to actually create their own, personalized jewelry.

There are another type of customization that can be done related to computer aided design (CAD) systems, where a person can build a jewelry model from elements library, render the final image and order the real jewelry. Disadvantageously, CAD systems required a professional assistant or professional knowledge of how to design jewelry, and operate the CAD software program. Our customization system are limit customer choices to simplify a design process and provide a image of final jewelry without need of assistant and in very short time.

Therefore, there is a need for a personalized jewelry customization system that displays ready-made smart jewelry element models, from a library, to a customer to construct a final jewelry model that is easy to use.

### BRIEF DESCRIPTION OF THE DRAWINGS

These and other features, aspects and advantages of the present invention will become better understood with regard to the following description, appended claims, and accompanying figures where:

FIG. 1 is a diagram of a personalized jewelry customization system that displays ready-made smart jewelry element models, from a library, to a customer to construct a final jewelry model that is easy to use, according to one embodiment;

FIG. 2 is a diagram of smart jewelry element models that can be assembled by the system of FIG. 1;

FIG. 3 is a diagram of some steps of a method for storing assembled smart jewelry element models in the system of FIG. 1;

FIG. 4 is a flowchart diagram of some steps of a method for storing jewel information into the system of FIG. 1;

FIG. 5 is a record of personalized jewelry attributes storable in a storage for later retrieval;

FIG. 6 is a record of gemstone attributes storable in a storage for later retrieval;

FIG. 7 is a record of ring attributes storable in a storage for later retrieval;

FIG. 8 is a diagram of different selectable ring attributes;

FIG. 9 is a flowchart diagram of some steps of a method for a personalized jewelry customization system that displays ready-made smart jewelry element models, from a library, to a customer to construct a final jewelry model that is easy to use;

FIG. 10 is a screenshot of the personalized jewelry customization system of FIG. 9, showing diamond selection;

FIG. 11 is a screenshot of the personalized jewelry customization system of FIG. 9, showing a mounting;

FIG. 12 is a screenshot of the personalized jewelry customization system of FIG. 9, showing ring size;

FIG. 13 is a screenshot of the personalized jewelry customization system of FIG. 9, showing head design;

FIG. 14 is a screenshot of the personalized jewelry customization system of FIG. 9, showing side settings;

FIG. 15 is a screenshot of the personalized jewelry customization system of FIG. 9, showing engraving designs;

FIG. 16 is a screenshot of the personalized jewelry customization system of FIG. 9, showing engraving text entry; and

FIG. 17 is a screenshot of the personalized jewelry customization system of FIG. 9, showing matching complementary jewelry.

### SUMMARY

The present invention overcomes the limitations of the prior art by providing a personalized jewelry customization system that displays ready-made smart jewelry element models, from a library, to a customer to construct a final jewelry model that is easy to use. Unlike other systems that simply change the color of an element, the system described herein allows a customer to create complex and personalized jewelry that would normally require a jewelry professional, easily. The customer can also make any changes to the jewelry at any time. Another aspect of the invention is that matching complementary jewelry pieces can be automatically generated from one final jewelry model created by the customer. For example a matching wedding band can be automatically created from the final model created by the customer. The system can show the pieces individually and together on a user interface so that the customer can see the complete set and make any changes to the jewelry before ordering. The rotatable 2D and 3D smart jewelry elements and final jewelry model allow the customer to see individual smart jewelry elements and the final jewelry model from any angle using a 360 degree rotation in each axis.

The system itself comprises one or more than one processor connected to a storage for storing executable instructions. The instructions executable on the one or more than one processor are for: a user interface displayable on a computing device for accepting jewelry customization instructions from a customer; a library of smart jewelry element models displayable on the user interface, where the customer can combine smart jewelry element models together to create a final jewelry model; a database for storing the final jewelry model, customer information and selection information; and automatically generated manufacturing instructions for the personalized jewelry and complementary jewelry based on the stored final jewelry model, customer information and selection information. The customer can use the user interface to arrange the smart jewelry element models to form a personalized jewelry item. The library of smart jewelry element models has fully rendered 2D and 3D smart jewelry element models for different jewelry pieces. The library also has pre-rendered images of all views as 2D images based on a 3D model. The pre-rendered images have rotation logic, where the customer can use a mouse or a touch screen to see different rotatable views of the 3D models.

The smart jewelry element models have attribute-value pairs that comprise rules to calculate if two or more smart jewelry element models can be combined together. One of the smart jewelry element models attributes are link locations. The link locations are used to connect and combined smart jewelry element models to each other, because the link locations are also connection points between selected smart jewelry element models. The connection points comprise instructions executable on the one or more than one processor so that the smart jewelry element models can only link to each other at appropriate connection points between connectable smart jewelry element models. For example, this prevents the customer from connecting pieces of a necklace to a ring. The connection points also comprise instructions executable on the one or more than one processor so that the smart jewelry element models can only link to each other in specific configurations between connectable smart jewelry element models.

The database for storing customer information and selection information comprises a unique identifier for each customer that is stored in the database for one or more than one jewelry item. The selection information comprises one or more than one identifier associated with one or more than one smart jewelry model stored in the library.

The automatically generated manufacturing instructions comprise details about the final jewelry model and matching jewelry, where the matching jewelry correctly fits the final model. As noted above, the matching jewelry is displayed on the user interface with the final jewelry model.

There is also provided a method for using a personalized jewelry customization system that displays ready-made smart jewelry element models, from a library, to a customer to construct a final jewelry model that is easy to use. The method comprises the steps of first providing the system. Then, providing customer information to be stored in the database. Next, displaying the user interface on a computing device. Then, constructing jewelry from one or more than one smart jewelry element models. Next, receiving the constructed jewelry from the customer. Finally, transmitting the manufacturing instructions for the constructed jewelry to a manufacturer to construct the customer's personalized jewelry.

There is also provided another computer-implemented method for a personalized jewelry customization system that displays ready-made smart jewelry element models, from a library, to a customer to construct a final jewelry model that is easy to use. The method comprises the steps of first, providing the system described herein. Then, selecting a diamond model displayed on the user interface. Next, selecting a size for the jewelry. Then, selecting a style of jewelry. Next, selecting a head design. Then, selecting a setting. Next, selecting an engraving and entering text to be engraved. Finally, selecting a type of metal to use in the personalized jewelry.

### DETAILED DESCRIPTION

The present invention overcomes the limitations of the prior art by providing a personalized jewelry customization system that displays ready-made smart jewelry element models, from a library, to a customer to construct a personalized custom jewelry final model. Using the system will provide near infinite combinations that can be easily added or changed will truly provide the customer with the personalized jewelry piece that they want. Additionally, once the custom jewelry has been created, the system can automatically design matching items for the customer, such as a matching wedding band from a customized engagement ring, or matching earrings or a necklace. Also, the system automatically generates construction details from the final model that can be sent to a third party manufacturer to complete the jewelry order. The system will store all the particulars of the custom jewelry so that the customer can return and re-create the exact item or embellish the item for a new jewelry piece. For example, a young newlywed couple with a limited budget may only be able to afford a basic ring. Years later, when they are more financially secure, they can return and create a more dramatic ring using the same ring design that they originally used, because all the information about the ring associated with that customer had been stored in the system. Also, the system allows for an easy replacement of a lost piece of jewelry. The customer only needs to enter the system and order from the saved pieces of customized jewelry without worrying if there are any details left out or forgotten.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems, methods and computer programs according to various embodiments disclosed. In this regard, each block in the flowchart or block diagrams can represent a module, segment, or portion of code, that can comprise one or more executable instructions for implementing the specified logical function(s). It should also be noted that, in some alternative implementations, the functions noted in the blocks may occur out of the order noted in the figures. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

In the following description, certain terminology is used to describe certain features of one or more embodiments of the invention.

The term “computing device” refers to a desktop computer, a laptop computer, a smartphone, a tablet, or any other device capable of displaying a user interface for transmitting and receiving and instructions from a server.

The term “gemstone” refers to any precious or semi-precious stones typically used in jewelry.

The term “metal” refers to any precious or semi-precious metals typically used in jewelry.

The term “ready-made smart jewelry element model” refers to a separate part of jewelry piece, presented as 3d CAD model. Where all views of 3d model as rendered with front view, top view, two sides view to show all needed details of element and it is possible to generate all 360 degree view images.

Various embodiments provide a personalized jewelry customization system that displays ready-made smart jewelry element models, from a library, to a customer to construct a final jewelry model that is easy to use. One embodiment of the present invention provides a personalized jewelry customization system that displays ready-made smart jewelry element models, from a library, to a customer to construct a final jewelry model that is easy to use. In another embodiment, there is provided a method for using the system. The system and method will now be disclosed in detail.

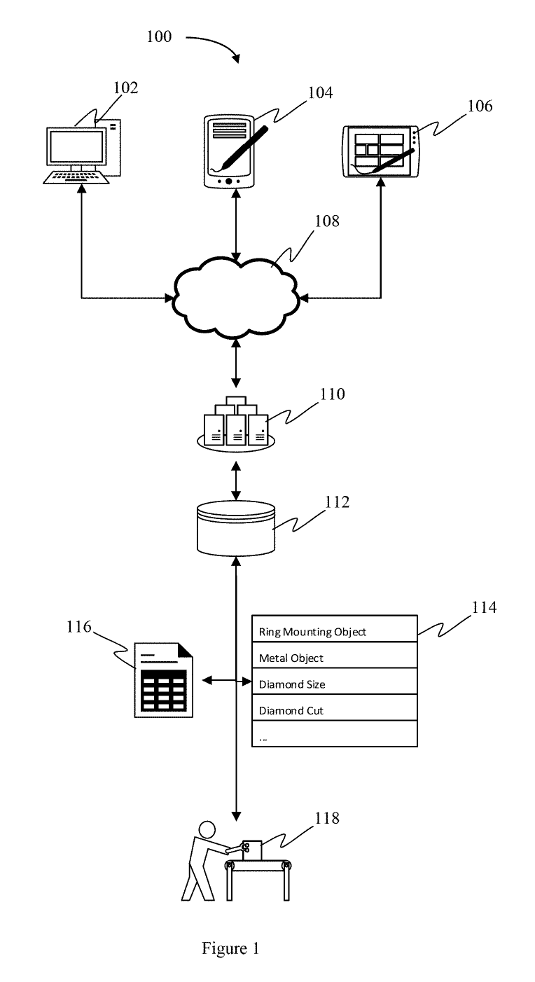

Referring now to FIG. 1, there is shown a FIG. 1 is a diagram of a personalized jewelry customization system 100 that displays ready-made smart jewelry element models from a library 116 to a customer to construct a final jewelry model that is easy to use, according to one embodiment. As can be seen the system 100 comprises instructions executable on one or more than one processor 110 for displaying a user interface on various computing devices 102, 104, and 106. The user interface displays steps to a customer for creating personalized jewelry. In this example, the jewelry is a ring, but as will be appreciated by those with skill in the art with reference to this disclosure, other jewelry, such as, for example, necklaces and earrings can also be created using the system. The ring example described herein is not intended to limit the jewelry options that can be created by the system.

The personalized jewelry customization system 100 comprises one or more than one processor 110, a storage 112 connected to the one or more than one processor for storing instructions executable on the one or more than one processor 110. The instructions display a user interface a computing device 102-106. There is also a library 114 of smart jewelry element models displayable on the user interface. Each of the smart jewelry element models in the library 114 further comprise have an element type, attributes, and link position(s) for each smart jewelry element model stored in the library 114. These attributes will be discussed in detail below. A database 112 is used for storing the library 114, customer and selection information 116. The customer and selection information 116 comprises a unique identifier for each customer, all the completed and partial jewelry items created by the customer, and each sub-component selected by the customer so that the customer can come back at a later date to create a new piece or re-create the original. For example, if the customer creates an engagement band, a wedding ring can be created automatically based off the design of the engagement ring. The customer simple selects the engagement ring and instructs the system to automatically generate manufacturing instructions 118 for the personalized jewelry and complementary jewelry based on the stored customer and selection information. In another example, if a ring, earring or necklace is lost, the customer can simply replace the ring, earring or necklace from the information stored in the database 112. A new version of the original(s) can be made, down to the engraving on the jewelry, without the customer worrying that they forgot something. Heirlooms lost to time or the elements can be reconstructed. Even copies of original designs can be remade.

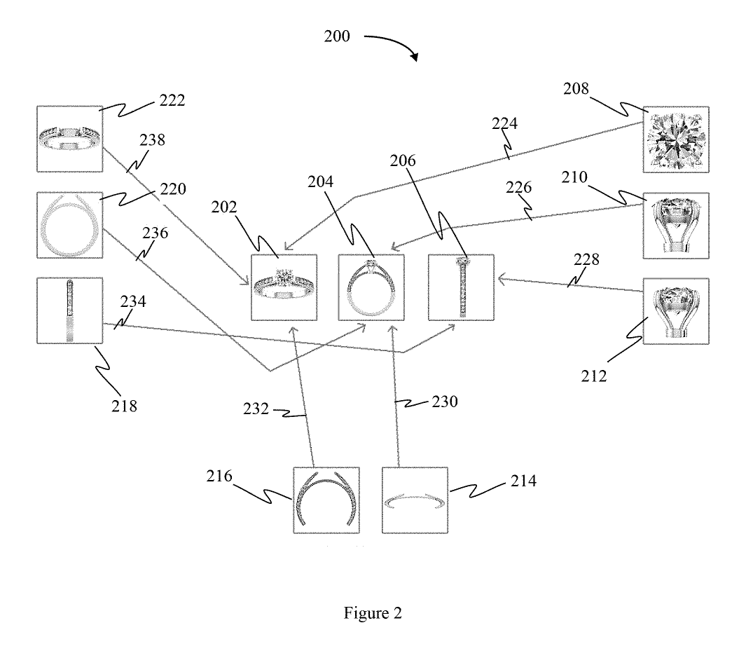

Referring now to FIG. 2, there is shown a diagram of smart jewelry element models 200 that can be assembled by the system of FIG. 1. The library 114 of smart jewelry element models comprise fully rendered 2D and 3D smart jewelry element models of jewelry 202, 204, 206, 208, 210, 212, 214, 216, 218, 220, and 222. Each of the smart jewelry element models 202-222 comprise attributes stored in the library 114. Each element model has a set of pairs of (Attribute-Value). These pairs are represent a required a semantic data based on what part of jewelry is represented of this element, their association with other element models. Each element model also has a set of link positions. For example, the attributes can be gemstone weight, shape, pattern, etc. One of the smart jewelry element models 202-222 attributes are link locations 224, 226, 228, 230, 232, 234, 236, and 238. The link locations 224-228 are positions on the smart jewelry element models where the element models 202-222 can be connected to each other in order to build a final model. The smart jewelry element models 202-222 link locations 224-238 contain information on how the smart jewelry element models 202-222 connect and where the smart jewelry element models 202-222 can connect to each other. The link locations 224-228 are connection points between selected smart jewelry element models 202-222. The link locations 224-238 comprise rules that are data used to represent general and exception logic how smart jewelry element models are linked to each other. In one embodiment, this logic comprises the following format: IF (condition) THEN (action). Where condition is pair or attribute-values to define element model and the action is a predicate to define is the smart jewelry element models 202-222 can be combined together into the final jewelry model. The final jewelry model, and all associated smart jewelry element models 202-222, can be retrieved by unique identifier.

As can be seen, the system 100 comprises instructions executable on the one or more than one processor 110 so that the smart jewelry element models 202-222 can only link to each other at appropriate connection points (links) between connectable smart jewelry element models 202-222. These link location 224-228 instructions make sure that the customer cannot mismatch components that do not belong together. This insures that the system 100 does not create a final jewelry model that is impossible to manufacture. The link locations 224-238 comprise instructions executable on the one or more than one processor 110 so that the smart jewelry element models 202-222 can only link to each other in specific configurations between connectable smart jewelry element models 202-222.

Each smart jewelry element model 202-222 comprise four 3d (x,y,z coordinate) dots on each smart jewelry element models 202-222 surface. They system 100 automatically selects two or more smart jewelry element models 202-222 with the same attribute TYPE but having different values. For example:

smart jewelry element model 1->type=HEAD

smart jewelry element model 2->type=MOUNTING

The system 100 comprises instructions executable on the processor to place the two smart jewelry element models together to find an intersection between them. If the intersection comprises four dots from the first smart jewelry element model and four dots from the second smart jewelry element model, the system 100 determines that the first and second smart jewelry element models can be connected to each other. The system 100 then generates a description of the smart jewelry element models where the two smart jewelry element models can be combined and provides options to the customer to select them. The system 100 then automatically generates a basic connection rule: (IF (condition) THEN (smart jewelry element models are compatible)) or an exception rule (IF (condition) THEN (smart jewelry element models are not compatible)). There are other possible connection rules that can be generate as will be understood by those with skill in the art with reference to this disclosure.

The system 100 also comprises instructions executable on the one or more than one processor and the database 112 to create and store a unique identifier for each customer. Each model created comprises a unique identifier that is stored with the customer's unique identifier. Every completed or partially constructed piece of jewelry is stored in the database 110. Additionally, the selected smart jewelry element models 202-224 are information each of the customer's jewelry items are also stored in the customer and selection information 116. The customer and selection information 116 comprises one or more than one identifier associated with one or more than one smart jewelry model stored in the library.

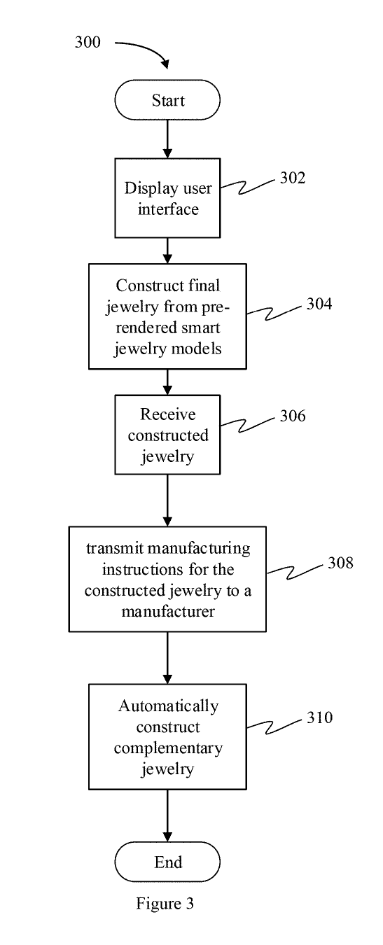

Referring now to FIG. 3, there is shown a diagram of some steps of a method 300 for storing assembled smart jewelry element models in the system of FIG. 1. First, using the system 100, the customer provides identifying information to be stored in the database 110. Next, the user interface is displayed 302 on the customer's computing device 102-106. Then, the customer constructs jewelry 304 from one or more than one smart jewelry element models. Next, the constructed jewelry is received 306 by the system 100 from the customer. Finally, the system transmits manufacturing instructions 308 for the constructed jewelry to a manufacturer to construct the customer's personalized jewelry. Optionally, complementary jewelry 310 can be constructed from the stored smart jewelry element models automatically without any further input from the customer based off of the originally created jewelry. For example, a wedding band can automatically be created to match a customer's engagement ring from a final model. Also, a necklace or earrings can be made from the same selected final model, or automatically designed and displayed to the customer as an incentive to purchase the items to match the custom final jewelry model just created.

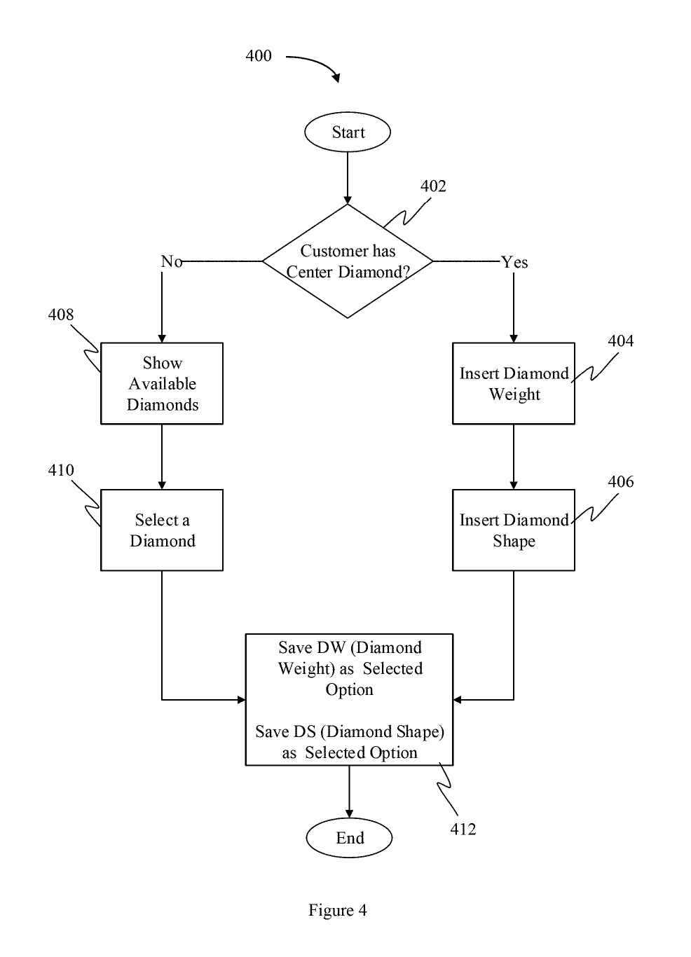

Referring now to FIG. 4, there is shown a flowchart diagram of some steps of a method 400 for storing jewel information into the system of FIG. 1. First, a determination 402 is made as to whether the customer has their own gems that they would like to have made into jewelry. If the customer has their own gems, the weight of the gem 404 is stored into the system 100. Because there are standard cuts for each type of gemstone, the library 114 can match smart jewelry element models 202-222 to the customer's gem so that only setting, mountings, etc. that can be used with the gem are displayed. This removes any guesswork for the customer or designer using the system 100. Alternatively, the customer can be shown a variety of available gems 408. The customer then selects a gem 410 from the gems available from a vendor. Finally, the gem weight and shape are stored 412 along with the customer's unique identifier in the system 100 and smart jewelry element models that are compatible with the gem's weight and shape can be automatically determined and displayed to the customer on the user interface so that other smart jewelry element models can be added to create the custom jewelry.

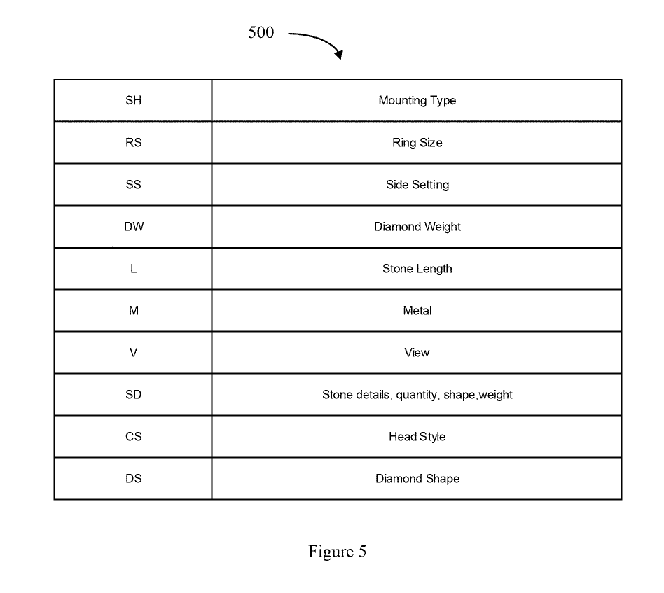

Referring now to FIG. 5, there is shown a record of personalized jewelry attributes 500 storable in a storage for later retrieval. As can be seen in this example, there are many attributes that can be associated with a piece of custom jewelry. Although not limited to, the attributes can be selected from the group consisting of mounting type, ring size, side setting, gem weight, stone length, metal, stone details, head style and gem shape, among other attributes.

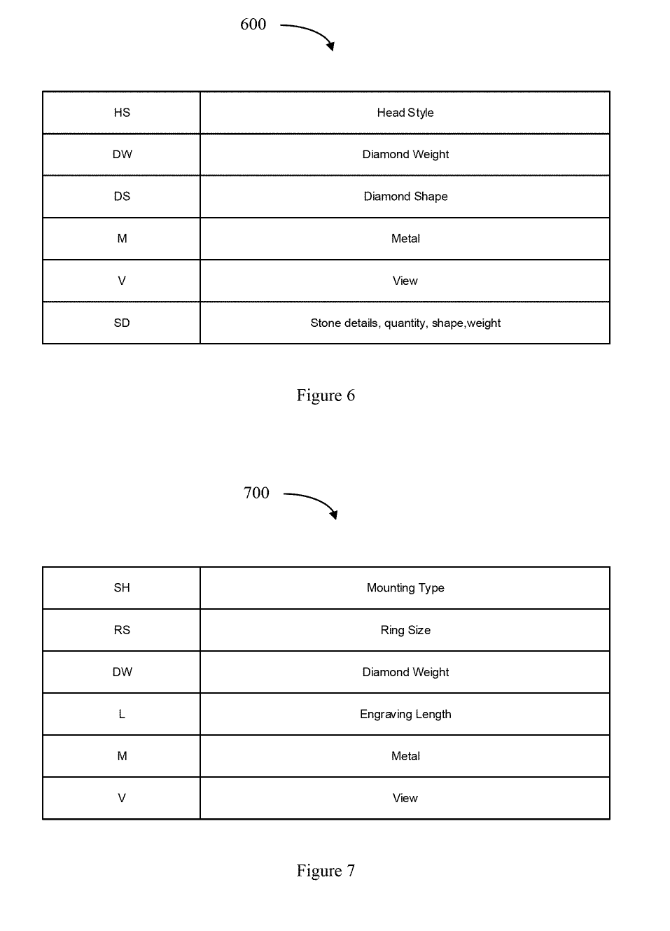

Referring now to FIG. 6, there is shown a record of gemstone attributes 600 storable in a storage for later retrieval. If the customer selects a particular gemstone, in this example, a diamond, the user and selection information 116 stored in the database 112 will also have a record of the gemstones attributes, such as, but not limited to, head style, weight, shape, metal, quantity, among other attributes that are used to determine the available smart jewelry element models that can be matched with the gemstone.

Referring now to FIG. 7, there is shown a record of ring attributes 700 storable in a storage for later retrieval. In this example, a ring, other attributes associated with the ring are stored in the user and selection information 116. These attributes 500, 600 and 700 make it possible to determine which smart jewelry element models can be used. Additionally, since these attributes can be used at a later date to recreate specific custom jewelry designs, the possibilities for repeat business increase.

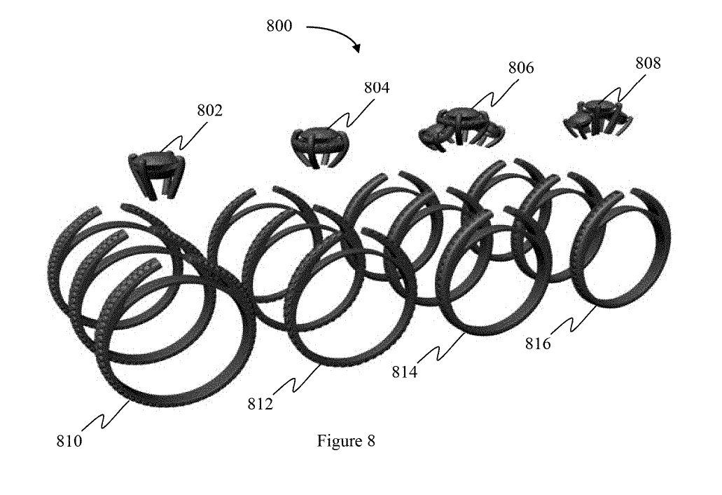

Referring now to FIG. 8, there is shown a diagram of different selectable ring attributes. As can be seen, there are several mountings 802, 804, 806 and 808 that can be used with the same gemstone. In some instances there are more than one gemstone 806 and 808 that can be used in the design. Also, there are several different mountings 820, 812, 814, 816 that can be selected to go with a selected mounting 802-808. The customer can mix and match various smart jewelry elements from each of the displayed items to create their final custom jewelry model. Some of the smart jewelry element models available are the prongs, accent stones, center stone, side stone, stations, gallery, rail, bearing, engraving, mounting and the mounting among others.

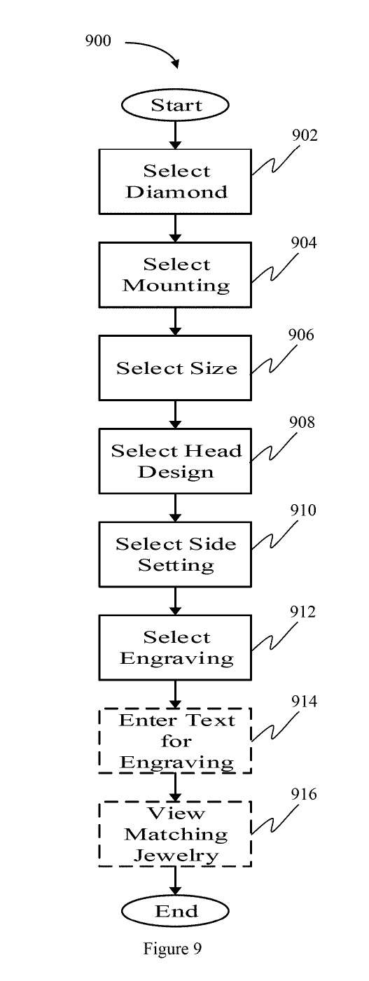

Referring now to FIG. 9, there is shown a flowchart diagram of some steps of a method for a personalized jewelry customization system that displays ready-made smart jewelry element models, from a library, to a customer to construct a final jewelry model that is easy to use. First, using the system 100 described above, the customer selects 902 a diamond smart jewelry model displayed on the user interface. Then, the customer selects a mounting 904. Next, the customer selects a size 906. Then, the customer selects a head design 908. Next, the customer selects a side setting 910 for the selected diamond 902. Then, the customer selects an engraving style 912, and then can optionally enter text to be engraved 914. Finally, the customer can optionally view matching complementary jewelry 916 based off the final jewelry model that the system 100 can display.

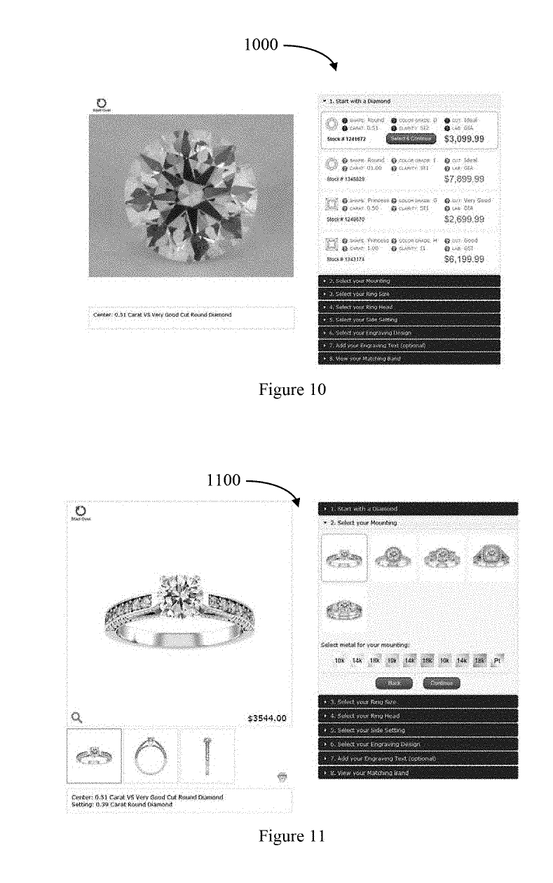

Referring now to FIG. 10, there is shown a screenshot of the personalized jewelry customization system of FIG. 9, showing diamond selection 1000. As can be seen in this example, the first step is to select a diamond 1000 from various available diamonds in stock. As will be appreciated by those with skill in the art with reference to this disclosure, other gemstones, such as rubies, emeralds, and opals among others, can also be used.

Referring now to FIG. 11, there is shown a screenshot of the personalized jewelry customization system of FIG. 9, showing a mounting 1100. The customer can select a mounting 1100 from the library 114 in an easy to find chart.

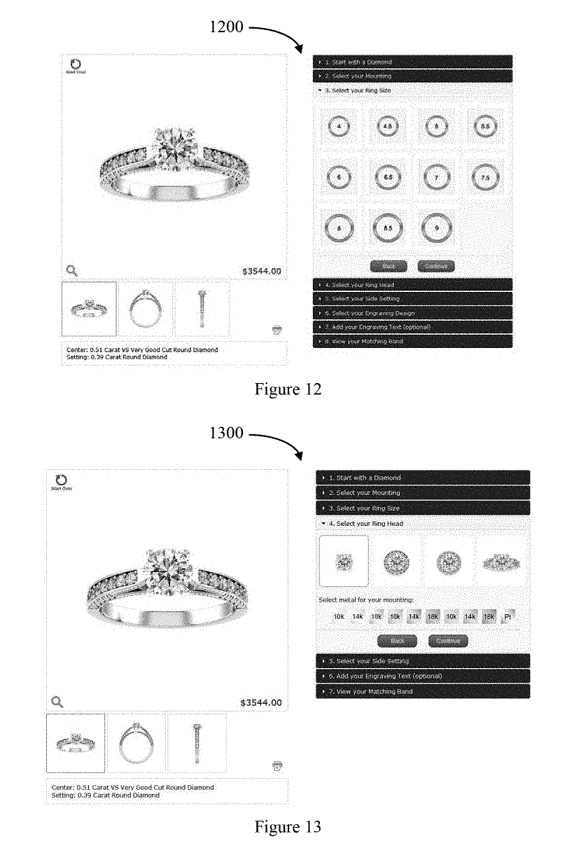

Referring now to FIG. 12, there is shown a screenshot of the personalized jewelry customization system of FIG. 9, showing ring size 1200. Once the diamond and the mounting are selected, the customer is presented with a selection of ring size 1200 selections.

Referring now to FIG. 13, there is shown a screenshot of the personalized jewelry customization system of FIG. 9, showing head design 1300. After the ring style 1200 is selected, matching head style 1300 smart jewelry element models are presented that will mate with the other previously selected option.

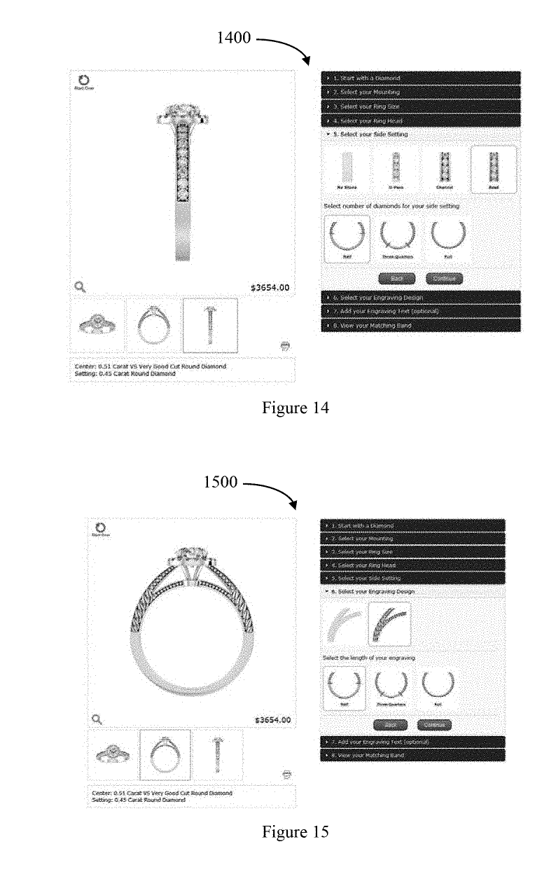

Referring now to FIG. 14, there is shown a screenshot of the personalized jewelry customization system of FIG. 9, showing side settings 1400. In this step, the customer has a significant amount of flexibility in the smart jewelry element models that can be added to the ring. The customer can select from a variety of side settings 1400 from the library 116 of smart jewelry element models.

Referring now to FIG. 15, there is shown a screenshot of the personalized jewelry customization system of FIG. 9, showing engraving designs 1500. Here the customer can select an engraving style 1500 for the ring. Also, the position of where the engraving is to be printed can be selected. The text for the engraving is also entered.

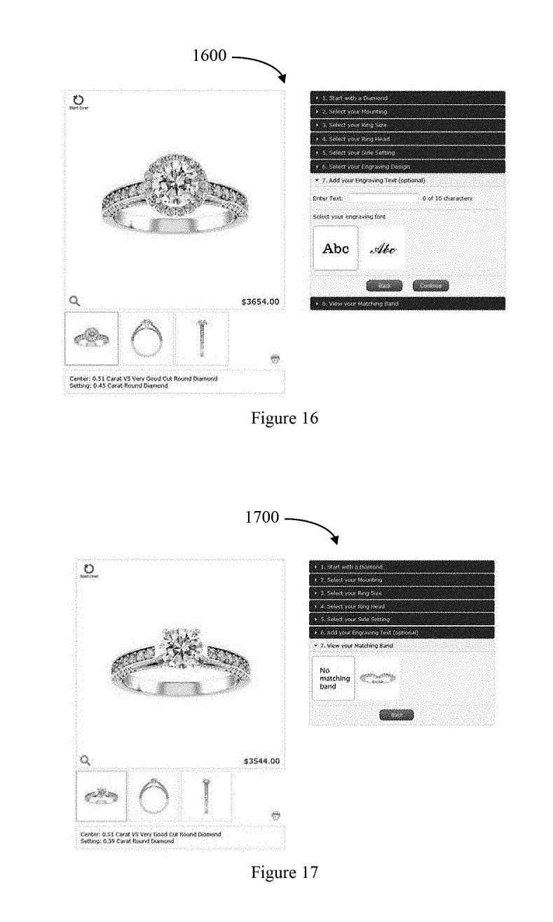

Referring now to FIG. 16, there is shown a screenshot of the personalized jewelry customization system of FIG. 9, showing engraving text entry 1600. If the customer has selected an engraving design 1500, then they can add the text to the engraving design here.

Referring now to FIG. 17, there is shown a screenshot of the personalized jewelry customization system of FIG. 9, showing matching complementary jewelry 1700. As cab be seen, any complementary jewelry that can be automatically generated by the system 100 is displayed once the final jewelry model is complete. This provides the customer with an instant preview of additional jewelry that can be purchased. Additionally, the customer can select the automatically generated matching complementary jewelry for further customization. This feature adds additional value for the customer to purchase sets of jewelry made in the same style that was created by the customer.

Using the system 100, the customer can see what the final jewelry and complementary jewelry will look like prior to making a final decision. Any of the previously selected items can be easily changed so there are a variety of ‘what if’ scenarios that the customer can preview before deciding. This is more than the prior art's color changing layers that don't reflect anything more than a standard catalog of rings and jewelry. The system 100 provides true customization options and based on selected options shows a final jewelry model from a customer selected set of pre-rendered smart jewelry elements 202-222 combined together. Additionally, using the smart jewelry element models provide the capability for anyone to design their own jewelry without spending hours with a jewelry designer. The smart jewelry element models have the intelligence built into them so that mistakes cannot be made. Only items that will work together can be linked to each other.

What has been described is a new and improved system and method for a personalized jewelry customization system that displays ready-made smart jewelry element models, from a library, to a customer to construct a final jewelry model that is easy to use, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A personalized jewelry customization system that displays ready-made smart jewelry element models, from a library, to a customer to construct a final jewelry model that is easy to use, the system comprising:
a) one or more than one processor comprising:
1) a storage connected to the one or more than one processor for storing instructions executable on the one or more than one processor;
b) instructions executable on the one or more than one processor for:
1) a user interface displayable on a computing device for accepting jewelry customization instructions from a customer;
2) a library of smart jewelry element models displayable on the user interface, where the customer can combine smart jewelry element models together to create a final jewelry model;
3) a database for storing the final jewelry model, customer information and selection information; and
4) automatically generated manufacturing instructions for the personalized jewelry and complementary jewelry based on the stored final jewelry model, customer information and selection information.

2. The system of claim 1, where the user interface can arrange the smart jewelry element models to form a personalized jewelry item.

3. The system of claim 1, where the library of smart jewelry element models comprise fully rendered 2D and 3D smart jewelry element models of different jewelry pieces.

4. The system of claim 3, where the library of smart jewelry element models comprise pre-rendered images of all views as 2D images based on a 3D model.

5. The system of claim 4, where the pre-rendered images comprise rotation logic, where the customer can use a mouse or a touch screen to see different rotatable views of the 3D models.

6. The system of claim 3, where the smart jewelry element models comprise attribute-value pairs.

7. The system of claim 6, where the attribute-value pairs comprise rules to calculate if two or more smart jewelry element models can be combined together.

8. The system of claim 6, where one of the smart jewelry element models attributes are link locations.

9. The system of claim 8, where the smart jewelry element models link locations connect smart jewelry element models to each other.

10. The system of claim 9, where the link locations are connection points between selected smart jewelry element models.

11. The system of claim 10, where the link locations are points on a 3D model where different smart jewelry element models can be combined together.

12. The system of claim 11, where the connection points comprise instructions executable on the one or more than one processor so that the smart jewelry element models can only link to each other at appropriate connection points between connectable smart jewelry element models.

13. The system of claim 10, where the connection points comprise instructions executable on the one or more than one processor so that the smart jewelry element models can only link to each other in specific configurations between connectable smart jewelry element models.

14. The system of claim 1, where the database for storing customer information and selection information comprises a unique identifier for each customer that is stored in the database.

15. The system of claim 14, where the database for storing customer information and selection information stores selection information for one or more than one jewelry item.

16. The system of claim 15, where the selection information comprises one or more than one identifier associated with one or more than one smart jewelry model stored in the library.

17. The system of claim 1, where the automatically generated manufacturing instructions comprise details about the final jewelry model and matching jewelry, where the matching jewelry correctly fits the final model.

18. The system of claim 17, where the matching jewelry is displayed on the user interface with the final jewelry model.

19. A method for using a personalized jewelry customization system that displays ready-made smart jewelry element models, from a library, to a customer to construct a final jewelry model that is easy to use, the method comprising the steps of:
a) providing the system of claim 1;
b) providing customer information to be stored in the database;
c) displaying the user interface on a computing device;
d) constructing jewelry from one or more than one smart jewelry element models;
e) receiving the constructed jewelry from the customer; and
f) transmitting the manufacturing instructions for the constructed jewelry to a manufacturer to construct the customer's personalized jewelry.

20. A computer-implemented method for a personalized jewelry customization system that displays ready-made smart jewelry element models, from a library, to a customer to construct a final jewelry model that is easy to use, the method comprising the steps of:
a) providing the system of claim 1;
b) selecting a diamond model displayed on the user interface;
c) selecting a size;
d) selecting a style;
e) selecting a head design;
f) selecting a setting;
g) selecting an engraving and entering text to be engraved; and
h) selecting a type of metal to use in the personalized jewelry.
